(19) United States
(12) Patent Application Publication
(10) Pub. No.: US 2010/0231459 A1
(43) Pub. Date: Sep. 16, 2010

(54) Communication Device

(75) Inventors: Toshihiko Kawata, Kanagawa-ken (JP); Shinichi Nakada, Kanagawa-ken (JP); Masaki Noji, Kanagawa-ken (JP)

Correspondence Address: Hogan Lovells US LLP, 1999 AVENUE OF THE STARS, SUITE 1400, LOS ANGELES, CA, 90067, US

(73) Assignee: KYOCERA CORPORATION, Kyoto-shi, Kyoto (JP)

(21) Appl. No.: 12/294,873

(22) PCT Filed: Mar. 28, 2007
(86) PCT No.: PCT/JP2007/056641

§ 371 Date: May 28, 2010

(30) Foreign Application Priority Data
Mar. 28, 2006 (JP) 2006-087466
Mar. 28, 2006 (JP) 2006-087467

(51) Int. Cl. H01Q 9/04; H01Q 1/24

(52) U.S. Cl. 343/702; 343/700 MS

(57) ABSTRACT

A communication device which solves a new problem, that is, a power amplifier has oscillation caused by providing a conductive body which reduces the effects of the noise on a chip antenna, includes: a chip antenna which catches radio waves of a desired frequency; an RF circuit which is implemented on a printed wiring board and which converts received signals input from the chip antenna to a low frequency; a digital circuit which is implemented on the printed wiring board and which demodulates the received signals in a low frequency input from the RF circuit; a conductive body which is extended between the chip antenna and the digital circuit while being maintained at a certain height from the printed wiring board, and which has an end connected to a ground conductive body of the printed wiring board; and a radio wave absorption body which is attached to the conductive body.

### TECHNICAL FIELD

1. Field of the Invention

The present invention relates to a communication device.

Priority is claimed on Japanese Patent Applications No. 2006-87466, filed Mar. 28, 2006 and No. 2006-87467, filed Mar. 28, 2006, the content of which is incorporated herein by reference.

2. Background Art

In both the past and the present, there are various types of communication devices for wireless communication to external apparatuses such as a base station, for example, there is a type of PC card which is used after insertion into an extended slot of a mobile terminal or a notebook type personal computer (hereinafter, a notebook personal computer).

Such a communication device provides an antenna for establishing a wireless communication to such a base station in order to transmit and receive radio waves, and in recent years, from the view point of an external appearance and cost, a chip antenna which is installed inside the case is used in stead of an antenna which is conventionally used and is extruded outside the case

However, in a case of using the chip antenna, due to its characteristics, there is a higher possibility than before in which the chip antenna receives noise generated by devices that are set around and close to the chip antenna, and as a result, there is a problem in which the ability of the chip antenna to receive radio waves of a desired wavelength is deteriorated. The device which is set around and close to the chip antenna is, for example, a digital circuit implemented on a printed wiring board on which the chip antenna is implemented together and the notebook personal computer if the communication device is a PC card type.

There are techniques that reduce the influence of the noise, that are shown in the Patent Documents 1 and 2.

Patent Document 1 shows a technique in which a ground wiring of a high frequency receiver and a ground wiring of a calculation operation circuit are independently provided in order to avoid the noise generated by the calculation operation circuit from being included into the high frequency receiver.

Patent Document 2 discloses a technique applied to a wireless communication card to which a spectrum diffusion method is applied and which includes: a card interface of such as a personal computer; modulation/demodulation means; a spectrum diffusion/opposite diffusion means; and a frequency modulation means, wherein the wireless communication card can be attached to a card slot, and the position of the antenna is set at least 10 cm apart from the personal computer.
[Patent Document 1] Japanese Patent Application, First Publication No. H09-64764
[Patent Document 2] Japanese Patent Application, First Publication No. H09-289471

Even in a case in which the ground wirings are independently provided as shown in the technique described in Patent Document 1, in a practical case it is not possible to achieve sufficient effects if a distance between the ground wirings is not sufficient. With regard to a board of a small device, in many cases, it is difficult to have a sufficient distance between the ground wirings.

In addition, the technique described in Patent Document 2 cannot be applied to a communication device in which the distance between the antenna and the device is necessarily 10 cm or smaller.

The present invention was conceived in order to solve the above-described problem and has an object to reduce the influence of the noise by applying a method with a low cost and without difficulty and to restrain factors which deteriorate the ability of the chip antenna to receive the radio waves.

In addition, the applicant has recognized that, by providing a conductive body which satisfies certain conditions and which is connected to the ground of the printed board, it is possible to reduce the deterioration of the receiving ability due to the noise generated by the digital circuit and the like.

However, there is a new problem in which a transmission state is unstable because a transmission amplifier causes an oscillation after providing the conductive body. With regard to this new problem, it is supposed that the oscillation is caused because of a combination of various conditions and parameters, for example, there are portions of the transmission power amplifier with a low stabilization index due to distribution caused in production steps. In addition, transmission signals are modulated in a high frequency by the RF circuit, supplied to the chip antenna for conducting the electric power amplification by the transmission amplifier and radiated in the air, and here, it is supposed that the transmission power amplifier oscillates because a return transmitted signals loop is formed when the transmission signals are electro-magnetically connected to the transmission power amplifier via the conductive body. In other words, in the conventional technique, there has been an unstable band in which an oscillation is generated in accordance with a combination of various conditions and parameters, and it has been desirable to avoid such an oscillation and achieve a further stable transmission operation.

### DISCLOSURE OF INVENTION

The present invention was conceived to solve the above-described problems and has an object to avoid a new problem that is oscillation of the power amplifier caused by providing a conductive body.

In order to solve the above-described problems, the present invention provides a first solution including: a chip antenna which catches radio waves of a desired frequency; an RF circuit which is implemented on a printed wiring board and which converts received signals input from the chip antenna to a low frequency; a digital circuit which is implemented on the printed wiring board and which demodulates the received signals in a low frequency input from the RF circuit; a conductive body which is extended between the chip antenna and the digital circuit while being maintained at a certain height from the printed wiring board, and which has an end connected to a ground conductive body of the printed wiring board; and a radio wave absorption body which is attached to the conductive body.

A second solution is applied which includes; a chip antenna which catches radio waves of a desired frequency and which has an electric length of a ¼ of a wavelength of the radio wave of the desired frequency; an RF circuit which is implemented on a printed wiring board and which converts received signals input from the chip antenna to a low frequency; a digital circuit which is implemented on the printed wiring board and which demodulates the received signals in a low frequency input from the RF circuit; a conductive body which has an electric length of a ¼ of a wavelength of the radio wave of the desired frequency, which is extended between the chip antenna and the digital circuit while being maintained at a certain height from the printed wiring board, and which has an end connected to a ground conductive body of the printed wiring board; and a radio wave absorption body which is attached to the conductive body.

A third solution according to the above-described first and second solutions is applied, in which the conductive body is constituted from a metallic plate of a strip shape, and the radio wave absorption body has a length of at least 2 mm along a lengthwise direction of the conductive body and has the substantially same length as a width of the conductive body along a width direction of the conductive body.

In order to solve the above-described problems, the present invention provides a fourth solution, including; a chip antenna which catches radio waves of a desired frequency; an RF circuit which is implemented on a printed wiring board and which amplifies and converts received signals input from the chip antenna to a low frequency; a digital circuit which is implemented on the printed wiring board and which demodulates the received signals in a low frequency input from the RF circuit; and a conductive body which is extended between the chip antenna and the digital circuit while being maintained at a certain height from the printed wiring board, and which has an end connected to a ground conductive body of the printed wiring board.

A solution is applied solution, that includes: a chip antenna which catches radio waves of a desired frequency and which has an electric length of a ¼ of a wavelength of the radio wave of the desired frequency; an RF circuit which is implemented on a printed wiring board and which amplifies and converts received signals input from the chip antenna to a low frequency; a digital circuit which is implemented on the printed wiring board and which demodulates the received signals in a low frequency input from the RE circuit; and a conductive body which has an, electric length of a ¼ of a wavelength of the radio wave of the desired frequency, which is extended between the chip antenna and the digital circuit while being maintained at a certain height from the printed wiring board, and which has an end connected to a ground conductive body of the printed wiring board.

A sixth solution according to the above-described fourth and fifth solutions is applied, in which the conductive body has a substantially L shape constituted from a metallic member in a strip shape, is curved at a position close to one end which is connected to the ground conductive body, and has a portion between the curved position and another end which is an open end is in parallel to the printed wiring body.

According to the present invention, an oscillation of the power amplifier is avoided by attaching a radio wave absorption body to the conductive body, hence it is possible to solve the new problem, that is an oscillation of the power amplifier, without deteriorating a function of reducing the influence of noises on the chip antenna.

In addition, in accordance with the present invention, by providing the conductive body, it is possible to reduce the degree of the noise that is generated by the closely installed devices and comes into the antenna chip.

Hence, by applying a low cost and easy solution of attaching a conductive body to the existing constitution, it is possible to reduce the influence of the noise and to exclude factors of deteriorating the receiving ability of the chip antenna.

### BRIEF DESCRIPTION OF THE DRAWINGS

FIG. 1 is a perspective view of an outside of a communication device in a case of applying a conductive body without providing a radio wave absorption body in one embodiment of the present invention.

FIG. 2 is a graph showing the transmission spectrum in a case of no oscillation of the power amplifier of the transmission device without attaching the radio wave absorption body to the conductive body in one embodiment of the present invention.

FIG. 3 is a graph showing a stabilization index among the chip antenna, an L shape metallic plate and the power amplifier without the attachment of the radio wave absorption body to the conductive body in one embodiment of the present invention.

FIG. 4A is a perspective view of the outside of a communication device in one embodiment of the present invention to which a conductive body providing a radio wave absorption body is applied.

FIG. 4B is a perspective view of a conductive body and a radio wave absorption body in one embodiment of the present invention.

FIG. 5 is a graph showing the transmission spectrum of the communication device in a case where the radio wave absorption body is attached to the conductive body according to one embodiment of the present invention.

FIG. 6 is a graph showing stability among the chip antenna, an L shape metallic plate and the power amplifier in a case where the radio wave absorption body is attached to the conductive body with regard to the communication device in one embodiment of the present invention.

FIG. 7 is a perspective view of the outside of the communication device according to one embodiment of the present invention.

FIG. 8 is a perspective view showing the outside and size of the L shape metallic plate according to one embodiment of the present invention.

FIG. 9 is a graph showing an improvement of a noise floor of one embodiment of the present invention.

### DESCRIPTION OF THE REFERENCE SYMBOLS

1 . . . printed wiring board
1a . . . connector
2 . . . chip antenna
3 . . . RF circuit
4 . . . digital circuit
5 . . . L shape metallic plate (conductive body)
5a . . . curved porion
5b . . . end portion
5c . . . portion
5d . . . end portion
6 . . . transmission portion
7 . . . receiving portion
8 . . . RFSAW filter
9 . . . power amplifier
10 . . . isolator
11. . . RF switch
12 . . . conductive body filter
13 . . . radio wave absorption body
21 . . . printed wiring board
21a . . . connector
22 . . . chip antenna
23 . . . RF circuit
24 . . . digital circuit
25 . . . L shape metallic plate (conductive body)
25a . . . curved portion
25b . . . end portion
25c . . . portion
25d . . . end portion

### BEST MODE FOR CARRYING OUT THE INVENTION

### First Embodiment

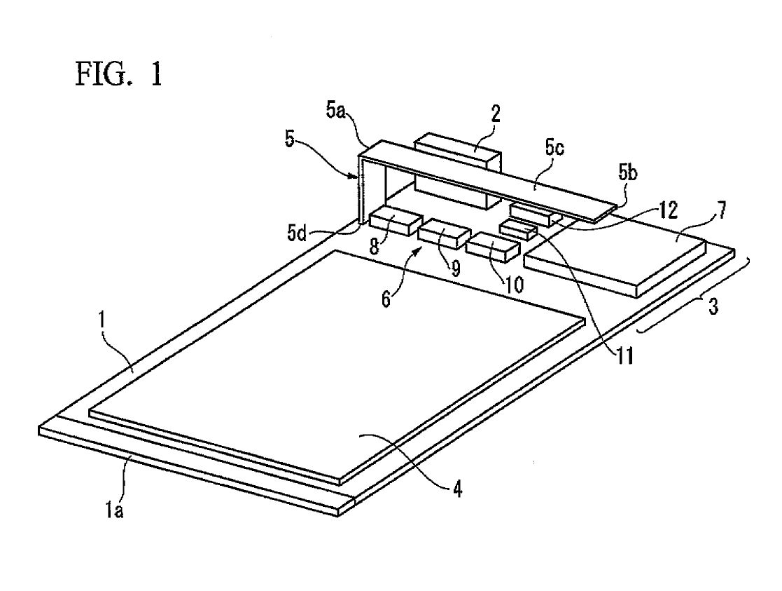

Hereinafter, in reference to FIGS. 1-6, one embodiment of a communication device of the present invention is explained. FIG. 1 is a perspective view of the outside of a communication device to which a solution for oscillation of the power amplifier is not applied. The communication device which is used while installed inside the case of a PC card includes: a printed wiring board 1; a chip antenna 2; an RF circuit portion 3; a digital circuit portion 4; and an L shape metallic plate 5 (conductive body). The RF circuit portion 3 has a constitution including a transmission portion 6 and a receiving portion 7, and the transmission portion 6 includes: an RFSAW filter 8; a power amplifier 9; an isolator 10; an RF switch 11; and a conductive body filter 12.

The printed wiring board 1 has a connector 1a at one end. The connector 1a is connected to a connector inside an extended slot of a notebook personal computer.

On the printed board 1, the chip antenna 2, the RF circuit portion 3 and the digital circuit portion 4 are provided in order from the side of the end opposite the connector 1a. In addition, the printed wiring board 1 has a ground conductive body to which the L shape metallic plate 5 is connected.

The chip antenna 2 is implemented so as to have a lengthwise direction which is substantially orthogonal to a direction on which the chip antenna 2, the RF circuit portion 3, and the digital circuit portion 4 are arranged on the printed wiring board 1.

The chip antenna 2 catches the received radio wave and outputs the radio wave as the received signal to the receiving portion 7 of the RE circuit portion 3, and the chip antenna 2 radiates the transmission signal as the transmission radio wave in the air that is input from the transmission portion 6 of the RF circuit portion 3.

The chip antenna 2 has an electric length equals to ¼ of the wavelength of the received radio wave or the transmission radio wave.

The receiving portion 7 of the RF circuit portion 3 converts the input signal (RF signal) input from the chip antenna 2 to a low frequency and outputs it to the digital circuit portion 4. The transmission portion 6 of the RF circuit 3 converts the signal input from the digital circuit portion 4 to the high frequency (to RF signal) and outputs the converted signal to the chip antenna 2.

In a detail explanation of an operation of the transmission portion 6 of the RF circuit 3, a band limitation operation is conducted on the modulated signal input from the digital circuit portion 4 after inputting into the RFSAW filter 8, the signal is input and amplified by the power amplifier 9, the signal is input by the conductive body filter 12 via the isolator 10 and the RF switch 11, and the signal is input by the chip antenna 2.

The digital circuit portion 4 demodulates the signal input from the receiving portion 7 of the RF circuit portion 3 and outputs the signal to the connector 1a, and the digital circuit portion 4 modulates the signal input from the connector 1a and outputs the signal to the transmission portion 6 of the RF circuit 3.

The L shape metallic plate 5 has a shape in which a portion close to one end of a metallic plate in a strip shape is curved in a substantially orthogonal angle, the end portion 5d is connected to the ground conductive body while the portion 5c which is between the end portion 5a apart from the curved portion 5a and the curved portion 5a is substantially in parallel to the printed wiring board 1, and the other end portion 5b is an open end.

The L shape metallic plate 5 has an electric length equals to an ¼ wavelength of the transmitted/received radio wave. In a case in which the transmission/received frequency of the chip antenna is in the 1.79 GHz band, the L shape metallic plate 5 has an appropriate shape in which, for example, a width is 6 mm, a length of the portion 5c is 33 mm that is a length between the end portion 5b which is an open end and the curved portion 5a, and a length between the curved portion 5a and the end portion 5d is 5 mm.

The L shape metallic plate 5 is provided in a manner in which the portion 5c between the end portion 5b which is the open end and the curved portion 5a is extended between the chip antenna 2 and the digital circuit portion 4 while maintaining a height or distance from the printed wiring board 1 so as to be 5 mm, and in addition, a length direction of the portion 5c is substantially parallel to a length direction of the chip antenna 2.

By providing the above-described L shape metallic plate 5, it is possible to avoid the reduction of receiving ability of the chip antenna 2 due to the noise generated from the devices set around and close to the chip antenna 2, but there is a possibility of a type of the power amplifier 9 having oscillation.

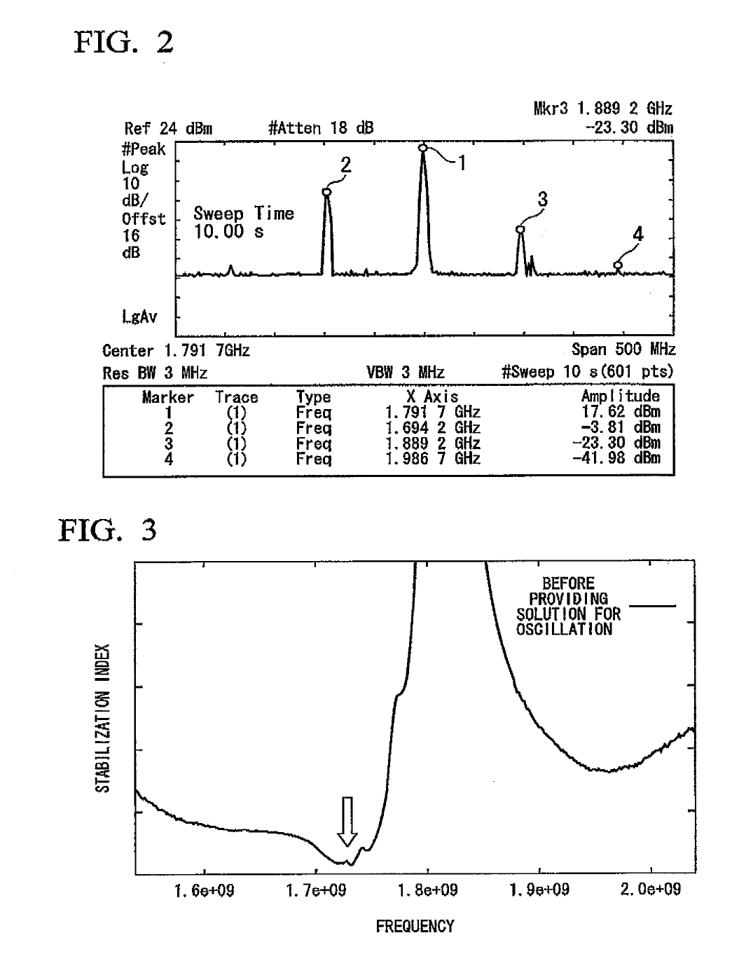

FIG. 2 is a graph showing a transmission spectrum while the power amplifier 9 is oscillating. As show here, when transmitting at a 1.79 GHz band in the above-described constitution, there is an oscillation of approximately 1.7 GHz.

FIG. 3 is a graph showing a stabilization index among the chip antenna, an L shape metallic plate and the power amplifier. The stabilization index is called a K factor that is an index showing a stable operation of the amplifier and the like, and is calculated in accordance with the following formula (1) by using an S parameter which shows a transfer characteristic of a circuit.

K=(1+|S₁₁S₂₂−S₁₂S₂₁|²−|S₁₁|²−|S₂₂²)/(2|S₁₂S₂₁|) (1)

If K>1, the circuit has a stable operation.

As shown in the graph, the stabilization index is deteriorated at approximately 1.7 GHz because of oscillation of the power amplifier 9.

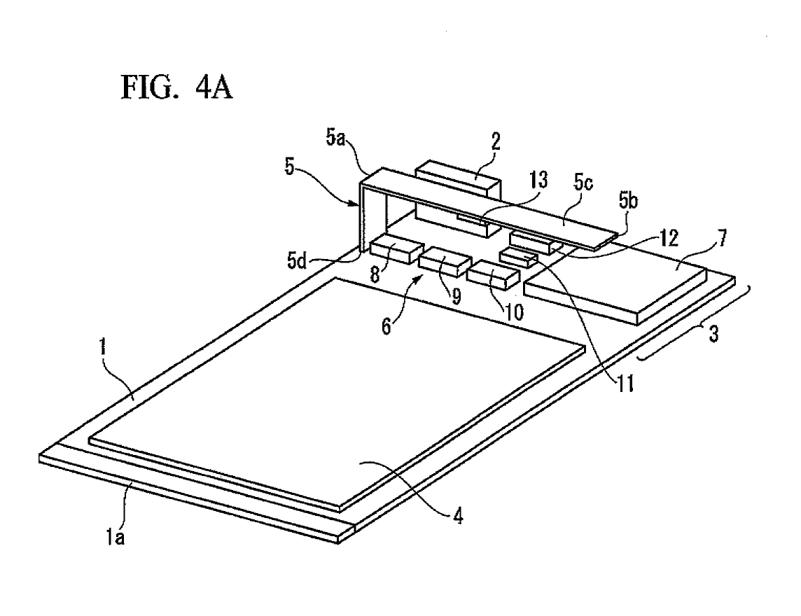

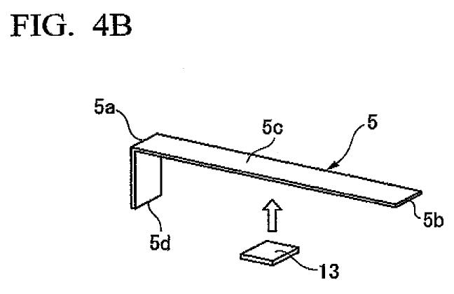

There is a constitution shown in FIGS. 4A and 4B that solves the above-described problem. In the constitution of FIGS. 4A and 4B, the radio wave absorption body 13 is attached to the L shape metallic plate 5.

In FIGS. 4A and 4B, the radio wave absorption body 13 is attached to a surface of the L shape metallic plate 5 that faces the printed wiring board 1 and faces the power amplifier 9, but in a practical implementation, it is possible to provide the radio wave absorption body 13 on other positions of the L shape metallic plate 5, and it is possible to have the same effects.

An appropriate size of the radio wave absorption body 13 is, for example, 5 mm of vertical×5 mm of sides×0.25 mm of thickness. In addition, it is possible to apply various materials to the radio wave absorption body, and for example, the radio wave absorption body made from a sheet of mixture of the synthetic rubber and the metallic magnetism powder is easily handled, hence it is easy to form such a radio wave absorption body into a desired shape and that can be easily attached to the L shape metallic plate 5.

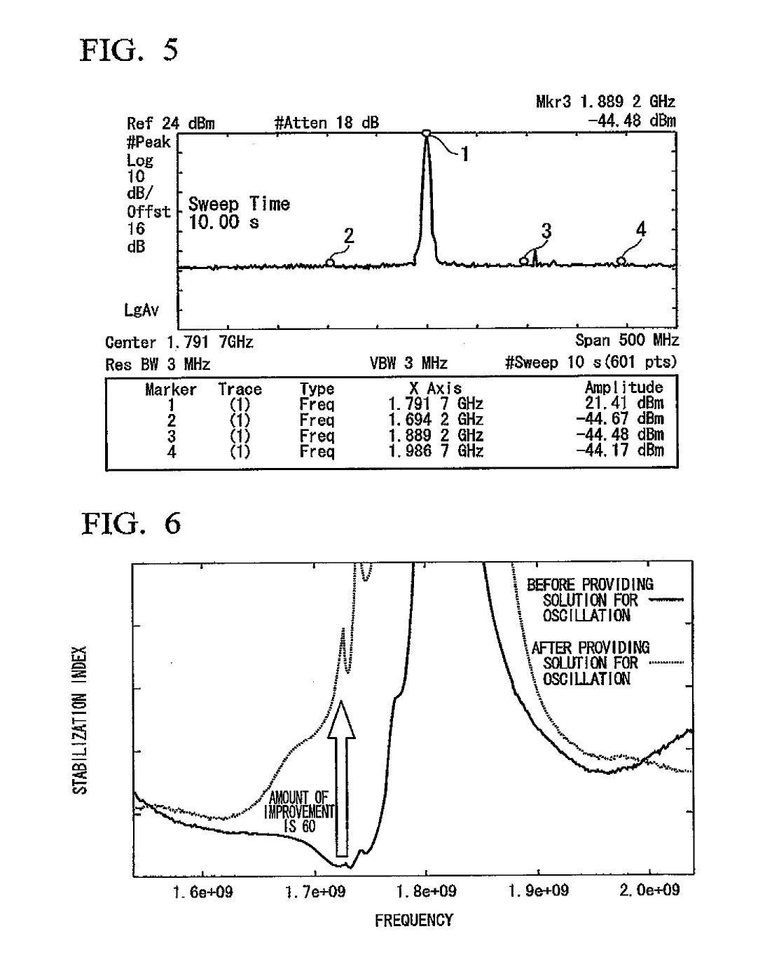

FIG. 5 is a graph showing a transmission spectrum of the communication device that has the constitution of FIGS. 4A and 4B. As shown here, it is possible to reduce oscillation.

FIG. 6 is a graph showing a stabilization index among the chip antenna, an L shape metallic plate and the power amplifier of the communication device that has the constitution of FIGS. 4A and 4B. As shown here, it is possible to improve the stabilization index at approximately 1.7 GHz.

As described above, in the communication device of the constitution of FIGS. 4A and 4B, it is possible to improve the receiving ability of the chip antenna by providing the L shape metallic plate 5, and in addition, it is possible to reduce the bad influence caused by providing the L shape metallic plate, that is, oscillation of the power amplifier 9.

It should be noted that in this embodiment, the L shape metallic plate 5 is used as the conductive body, but in a practical implementation, it is possible to apply other shapes, for example, it is supposed that a shape can be applied which is formed by curving a metallic column bar.

In addition, in this embodiment, one example of the communication device is explained which is installed inside the case of the PC card, but in a practical implementation, the communication device can otherwise be such as a mobile terminal.

### Second Embodiment

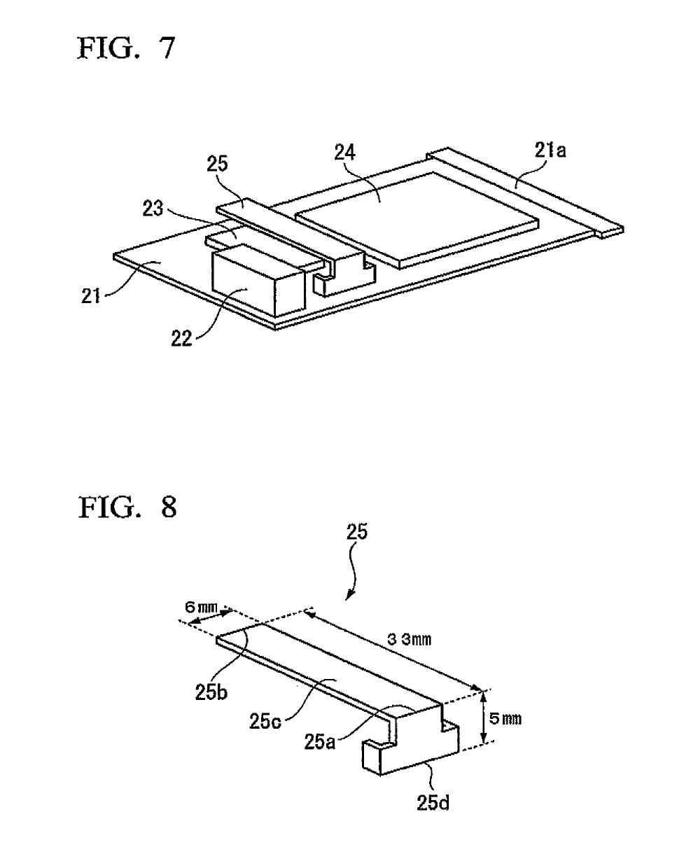

Hereinafter, in reference to FIGS. 7-9, a second embodiment of the present invention is explained. FIG. 7 is a perspective view of the outside of the communication device of this embodiment. The communication device which is used in a state of being installed inside a case of a PC card includes: a printed wiring board 21; a chip antenna 22; an RF circuit portion 23; a digital circuit portion 24; and an L shape metallic plate 25 (conductive body).

The printed wiring board 21 has a connector 21a at one end. The connector 21a is connected to a connector inside an extended slot of a notebook personal computer.

On the printed board 21, the chip antenna 22, the RF circuit portion 23 and the digital circuit portion 24 are provided in this order from a side of an end opposite to the connector 21a. In addition, the printed wiring board 21 has a ground conductive body to which the L shape metallic plate 25 is connected.

The chip antenna 22 is implemented so as to have a lengthwise direction which is substantially orthogonal compared to a direction in which, on the printed wiring board 21, the chip antenna 22, the RF circuit portion 23, and the digital circuit portion 24 are arranged.

The chip antenna 22 catches the received radio wave and outputs the radio wave as the received signal to the RF circuit portion 23, and the chip antenna 22 radiates the transmission signal as the transmission radio wave in the air that is input from the RF circuit portion 23.

The chip antenna 22 has an electric length equals to an ¼ wavelength of the received radio wave or the transmission radio wave.

The RF circuit portion 23 converts the input signal (RF signal) input from the chip antenna 22 to a low frequency and outputs it to the digital circuit portion 24, and the RF circuit portion 23 converts the signal input from the digital circuit portion 24 to the high frequency (to RF signal) and outputs the converted signal to the chip antenna.

The digital circuit portion 24 demodulates the signal input from the RF circuit portion 23 and outputs the signal to the connector 21a, and the digital circuit portion 24 modulates the signal input from the connector 21a and output the signal to the RF circuit 23.

The L shape metallic plate 25 has a shape in which a portion close to one end of a metallic member in a strip shape is curved in a substantially orthogonal angle, as shown in FIG. 8, the end portion 25d is connected to the ground conductive body while the portion 25c which is between the end portion 25a apart from the curved portion 25a and the curved portion 25a is substantially in parallel to the printed wiring board 21, and the other end portion 25b is an open end.

The L shape metallic plate 25 has an electric length equals to ¼ of the wavelength of the transmitted/received radio wave. In a case in which the transmission/received frequency of the chip antenna is in a band of 1.79 GHz, the L shape metallic plate 25 has an appropriate shape in which, for example, a width is 6 mm, a length of the portion 25c that is a length between the end portion 25b which is an open end and the curved portion 25a is 33 mm, and a length between the curved portion 25a and the end portion 25d is 5 mm.

The L shape metallic plate 25 is provided in a manner in which the portion 25c between the end portion 25b which is the open end and the curved portion 25a is extended between the chip antenna 22 and the digital circuit portion 24 while maintaining a height or space from the printed wiring board 21 so as to be 5 mm, and in addition, the length direction of the portion 25c is in substantially parallel to the length direction of the chip antenna 22.

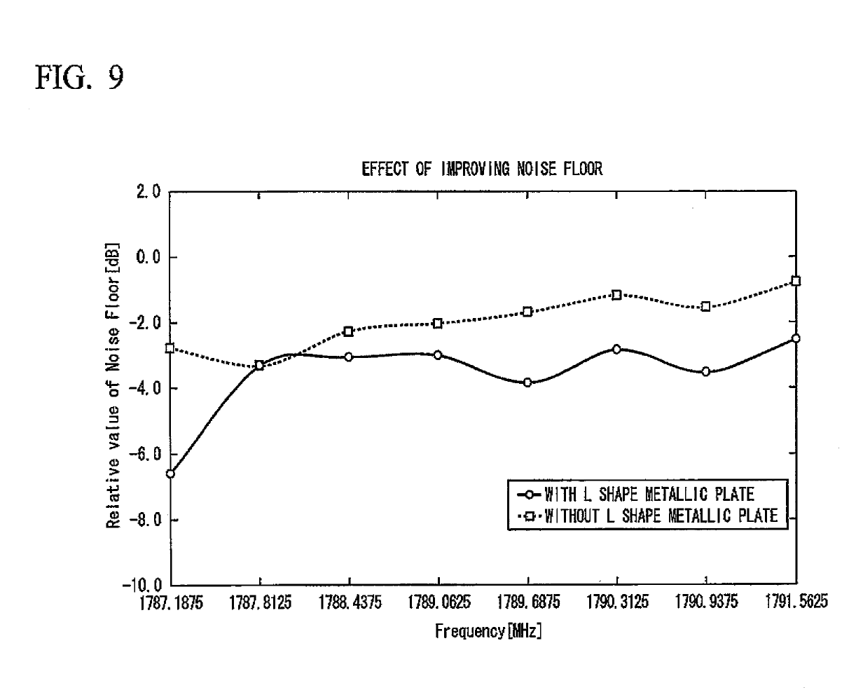

FIG. 9 is a graph showing improvement results of a noise floor after attaching a PC card to a notebook personal computer while the PC card include a communication device of the above-described constitution inside its case. A solid line shows the noise floor in a case of providing the L shape metallic panel 25 in a manner shown in the above-described constitution, and a broken line shows the noise floor in a conventional case in which the L shape metallic panel 25 is not provided.

In accordance with the experiments, without the L shape metallic panel 25, the noise floor fluctuates in a range of approximately −2.0 dB throughout the overall frequency. Compared to this, the noise floor of a case with the L shape metallic panel 25 is 0-4.0 dB lower, and in addition, when providing the L shape metallic panel 25, there is an advantage of a 2 dB improvement in the average. The applicant supposes that the reason for the improved effects is the lower noise caused by changes in distribution of the current on the printed wiring board 21 after attachment of the L shape metallic panel 25.

Therefore, in accordance with the experiments, it is possible to say that the noise floor is improved even when the notebook personal computer is turned on.

As described above, in the communication device, by applying an easy solution with a low cost, that is, by providing the L shape metallic plate 5, it is possible to reduce the bad influence caused by the noise, and it is possible to exclude a factor of deteriorating the receiving ability of the chip antenna.

It should be noted that, in this embodiment, the conductive body is the L shape metallic plate 25, but it is possible to use other shapes in a practical implementation, for example, it is possible to use a curved metallic column bar.

In addition, in this embodiment, an example of the communication device that is installed inside a case of the PC card is explained, but in a practical implementation, the communication device can be a mobile terminal, or the like.

### INDUSTRIAL APPLICABILITY

In accordance with the present invention, by attaching the radio wave absorption body to the conductive body, it is possible to avoid oscillation of the power amplifier, hence, without deteriorating the function of reducing bad effects of the noise on the chip antenna, it is possible to avoid a new problem caused by providing the conductive body, that is, oscillation of the power amplifier.

1. A communication device comprising:
a chip antenna which catches radio waves of a desired frequency;
an RF circuit which is implemented on a printed wiring board and which converts received signals input from the chip antenna to a low frequency;
a digital circuit which is implemented on the printed wiring board and which demodulates the received signals in a low frequency input from the RF circuit;
a conductive body which is extended between the chip antenna and the digital circuit while being maintained at a certain height from the printed wiring board, and which has an end connected to a ground conductive body of the printed wiring board; and
a radio wave absorption body which is attached to the conductive body.

2. A communication device comprising:
a chip antenna which catches radio waves of a desired frequency and which has an electric length of ¼ of wavelength of the radio wave of the desired frequency;
an RF circuit which is implemented on a printed wiring board and which converts received signals input from the chip antenna to a low frequency;
a digital circuit which is implemented on the printed wiring board and which demodulates the received signals in a low frequency input from the RF circuit;
a conductive body which has an electric length of ¼ of the wavelength of the radio wave of the desired frequency, which is extended between the chip antenna and the digital circuit while being maintained at a certain height from the printed wiring board, and which has an end connected to a ground conductive body of the printed wiring board; and
a radio wave absorption body which is attached to the conductive body.

3. A communication device according to claim 1, wherein
the conductive body is constituted from a metallic plate of a strip shape, and
the radio wave absorption body has a length of at least 2 mm along a lengthwise direction of the conductive body and has substantially the same length as the width of the conductive body along a width direction of the conductive body.

4. A communication device comprising:
a chip antenna which catches radio waves of a desired frequency;
an RF circuit which is implemented on a printed wiring board and which amplifies and converts received signals input from the chip antenna to a low frequency;
a digital circuit which is implemented on the printed wiring board and which demodulates the received signals in a low frequency input from the RF circuit; and
a conductive body which is extended between the chip antenna and the digital circuit while being maintained at a certain height from the printed wiring board, and which has an end connected to a ground conductive body of the printed wiring board.

5. A communication device comprising:
a chip antenna which catches radio waves of a desired frequency and which has an electric length of ¼ of wavelength of a radio wave of the desired frequency;
an RF circuit which is implemented on a printed wiring board and which amplifies and converts received signals input from the chip antenna to a low frequency;
a digital circuit which is implemented on the printed wiring board and which demodulates the received signals in a low frequency input from the RF circuit; and
a conductive body which has an electric length of ¼ of the wavelength of a radio wave of the desired frequency, which is extended between the chip antenna and the digital circuit while being maintained at a certain height from the printed wiring board, and which has an end connected to a ground conductive body of the printed wiring board.

6. A communication device according to claim 4,
wherein the conductive body has a substantially L shape constituted from a metallic member in a strip shape, is curved at a position close to one end which is connected to the ground conductive body, and
wherein the conductive body has a portion in parallel to the printed wiring body that is between the curved position and the other end which is an open end.
